(19) United States
(12) Patent Application Publication
(10) Pub. No.: US 2023/0167800 A1
(43) Pub. Date: Jun. 1, 2023

(54) WIND TURBINE ROTOR BLADE WITH COVERED ACCESS WINDOW

(71) Applicant: LM Wind Power A/S, Kolding (DK)

(72) Inventor: Graham Andress Aldinger, Greenville, SC (US)

(21) Appl. No.: 17/921,684

(22) PCT Filed: Apr. 28, 2021
(86) PCT No.: PCT/US2021/029571

§ 371 Date: Oct. 27, 2022

Related U.S. Application Data
(63) Continuation of application No. 16/860,852, filed on Apr. 28, 2020, now abandoned.

(51) Int. Cl. F03D 1/06; F03D 13/10

(52) U.S. Cl. CPC F03D 1/0675; F03D 13/10; F05B 2230/60; F05B 2240/302

(57) ABSTRACT

The present invention relates to a wind turbine blade with an access window extending through the blade. A cover member for covering the access window is provided, such that a first end of the cover member is pivotally connected to the outer surface of the blade and a second end of the cover member is releasably fastened to the outer surface of the blade.

### FIELD OF THE INVENTION

The present invention relates to wind turbine blade with an access window extending through its shell body for accessing an interior space of the blade. In addition, the present invention relates to methods of manufacturing said blade.

### BACKGROUND OF THE INVENTION

Wind power is one of the fastest-growing renewable energy technologies and provides a clean and environmentally friendly source of energy. Typically, wind turbines comprise a tower, generator, gearbox, nacelle, and one or more rotor blades. The kinetic energy of wind is captured using known airfoil principles. Modern wind turbines may have rotor blades that exceed 90 meters in length.

Wind turbine blades are usually manufactured by forming a shell body from two shell parts or shell halves comprising layers of woven fabric or fibre and resin. Spar caps or main laminates are placed or integrated in the shell halves and may be combined with shear webs or spar beams to form structural support members. Spar caps or main laminates may be joined to, or integrated within, the inside of the suction and pressure halves of the shell.

As the size of wind turbines increases, the manufacturing and transporting of wind turbine blades becomes more challenging and costly. As a solution to this problem wind turbine blades can be provided in two or more segments. This can result in an easier manufacturing process and may reduce the cost of transportation and erection of wind turbines. The respective blade segments may be transported to the erection site individually, where they can be assembled to form the wind turbine blade.

However, several challenges are associated with such segmented design. These often relate to the manufacturing and joining of the shell segments including load bearing structures such as spar beams, shear webs or other internal components. Due to the fact that internal parts of a wind turbine blade may have to be connected or disconnected as part of such processes, a suitable access solution needs to be provided to access internal blade parts from the outside of the blade.

WO 2011/067323 A2 discloses a sectional blade for a wind turbine, the blade comprising a first and a second blade section extending in opposite directions from a blade joint and being structurally connected by a spar bridge. A receiving section holds the spar bridge via a bearing member, which comprises two bearing halves. The bearing halves are assembled by bolts and connected to a spar section. The bolts may be tightened through openings in the blade shells, which may be filled afterwards to provide a smooth outer surface of the blade.

WO 2012/167891 A1 relates to a rotor blade of a wind turbine having an accessible cavity, wherein the rotor blade shell has a closable opening with a hatch closing flush with the outer layer of the rotor blade shell. The opening is designed for rescuing maintenance workers in the event of an accident or emergency. The hatch is permanently attached to the shell with a hinge for opening the hatch with an inwardly or outwardly directed pivot movement.

Some existing access solutions include a number of additional manufacturing steps when moulding the shell body of the blade. This will often require additional manufacturing steps such as the moulding of recessed blade areas. Also, these solutions include large number of parts, adding to the complexity and cost of such processes. There is consequently a need in the art for providing an improved and/or simplified access solution for wind turbine blades.

It is therefore an object of the present invention to provide a wind turbine blade with an improved access opening and closing and engaging arrangement.

Particularly, it is an object of the present invention to provide an access opening arrangement for a wind turbine blade or related structures that is easy to manufacture and to assemble.

It is another object of the present invention to provide an access opening arrangement for a wind turbine blade or related structures that has minimal impact on blade performance, such as aerodynamic properties.

It is another object of the present invention to provide an access opening arrangement for a wind turbine blade or related structures that has reduced part count and reduced part complexity.

### SUMMARY OF THE INVENTION

It has been found that one or more of the aforementioned objects can be obtained by a wind turbine blade having a profiled contour including a pressure side and a suction side, and a leading edge and a trailing edge with a chord having a chord length extending therebetween, the wind turbine blade extending in a spanwise direction between a root end and a tip end, wherein the blade comprises
an outer surface,
an access window extending through the blade,
a cover member for covering the access window, wherein a first end of the cover member is pivotally connected to the outer surface of the blade and a second end of the cover member is releasably fastened to the outer surface of the blade.

Such rotor blades can be manufactured with significantly reduced part count and reduced design complexity. The cover member is retained on the outer surface to cover the access window with fastening mechanism such as but not limited to push latch, magnetic latch, and twist latch. Advantageously, these fastening mechanisms reduce aerodynamic impact by reducing the profile of the components of the fastening mechanism relative to the outer surface of the blade. In addition, the use cover member which can be fastened to the outer surface of the blade provides a safer and more stable configuration as compared to some of the known access arrangements, thus preventing undesired separation of the cover member from the blade.

In addition, the configuration of the fastening mechanism and the cover member does not alter aerodynamic properties of the wind turbine blade, and thus have minimum or no effect on the performance of the wind turbine blade.

The blade will typically comprise two shell halves, a pressure side shell half, and a suction side shell half. The shell halves, optionally including one or more types of coating, usually form a continuous outer surface of the blade. Preferably, the outer surface of the blade serves as an aerodynamic surface when the blade is subjected to an air stream.

The access window may advantageously be configured to provide access to the interior of at least a portion of the rotor blade. The access window may be cut out or drilled through the shell body using a drill jig. It is preferred that the access window is formed in the suction side shell half of the blade. Preferably, the access window is configured to allow access to an internal spar element or shear web of the blade. Preferably, the access window is disposed between a spar element, such as a box spar, and the trailing edge of the blade. The access window may be provided by cutting the shell to form a cut-out section into and through the shell body and removing the cut-out section to provide the access window. To this end, a template or jig of the cut-out section can be placed on the outer surface of the shell body.

In a preferred embodiment, the access window is substantially rectangular, such as a rectangular shape with rounded corners. Thus, the access window may be formed by cutting a substantially rectangular opening into the shell, preferably into the suction side shell half of the blade, such that the shell is penetrated to allow access to an interior part of the blade.

In a preferred embodiment, the cover member is configured to cover the access window. The first end of the cover member is pivotally connected to the outer surface of the blade and the second end of the cover member is releasably fastened to the outer surface of the blade. In an advantageous embodiment, the cover member has a substantially rectangular shape, such as a rectangular shape with rounded corners, such as the periphery of the cover member flushes with a periphery of the access window. In another embodiment, the cover member substantially flushes with the outer surface of the blade.

The first end of the cover member may be hinged to the outer surface of the blade, such that the cover member pivots about the first end. The pivotal movement of the cover member facilitates operation of the cover member between open position and closed position. In the open position interior parts of the blade may be accessed through the access window. Preferably, the open position of the cover member corresponds to at least 50%, such as at least 75%, or at least 90% of the area of the access window.

In the closed position, the second end of the cover member is releasably fastened to the outer surface of the blade through a fastening mechanism. The fastening mechanism comprises a male fastening member and a female fastening member.

According to one embodiment, the male fastening member is provisioned at the second end of the cover member and the female fastening member is provisioned at the outer surface of the blade. The female fastening member is configured to accommodate the male fastening member and thus fasten the cover member with the outer surface of the blade to cover the access window.

According to one embodiment, the fastening mechanism is a push-latch mechanism.

According to one embodiment, the fastening mechanism is a twist-latch mechanism.

According to one embodiment, the fastening mechanism is a magnetic latch.

The cover member will usually comprise an outer surface and an opposing inner surface, wherein the inner surfaces faces towards the interior of the wind turbine blade when the cover member is in the closed position. The outer surface of the cover member can be a curved or profiled surface, which preferably has the same curvature or profile as the outer surface of the shell member at that location of the blade. In some embodiments, the cover member comprises a material same as that of the wind turbine blade.

According to one embodiment, the access opening allows for inserting and/or withdrawing a chordwise locking pin into an internal blade element, such as a spar structure, preferably a spar beam or box spar.

Preferably, the wind turbine blade of the present invention may comprise at least one locking pin for releasably locking two or more spar elements to each other. The wind turbine blade of the present invention preferably comprises two or more segments, such as a tip end segment and a root end segment, each segment comprising a pressure side shell member and a suction side shell member. Typically, the wind turbine blade comprises one or more shear webs or spar beams. In some embodiments, a first spar structure is arranged in a first blade segment and a second spar structure is arranged in a second blade segment.

In a preferred embodiment, the cover member substantially flushes with the outer surface of the blade such that it provides aerodynamic continuity of the aerodynamic foil. It was found that this configuration allows for a considerably easier manufacturing process as compared to known access solutions for wind turbine blades and does not generate additional noise while in operation. Additionally, the cover member controls ingress/egress of liquid and debris.

Typically, the shell body comprises a pressure side shell member and at least one suction side shell member.

In a preferred embodiment, at least one sealing member is arranged between the cover member and the outer surface of the blade. This advantageously leads to a tight fit and to an efficient barrier to moisture and/or debris through the closed access window. The sealing member will preferably be a gasket, preferably an annular gasket which usually has substantially the same shape as the outer circumference of the cover member. The sealing member may be adhesively fastened or bonded to the outer surface of the blade.

In a preferred embodiment, the sealing member is an annular gasket, preferably comprising an ethylene propylene diene monomer (EPDM) material, such as a EPDM sponge rubber or EPDM foam. In some embodiments, the frame opening has a height of 450-650 mm, such as 500-600 mm, and a width of 350-550 mm, such as 400-500 mm. In a preferred embodiment, the frame opening covers an area of not more than 0.25 m2, such as not more than 0.2 m2. It was found that such comparatively small openings lead to minimal aerodynamic disturbance yet allowing the servicing of internal parts such as locking pin arrangements and connections of a lightning protection system.

In another embodiment, the access opening arrangement further comprises a self-adhesive layer provided between the cover member and the outer surface of the blade. According to one embodiment, the cover member is substantially made of the same material as the blade shell body.

In a preferred embodiment, the frame is adhesively bonded to the shell member. In some embodiments, double-sided tape, glue, resin or a similar adhesive material is used in this regard.

In another aspect, the present invention relates to a method of manufacturing a wind turbine blade having a profiled contour including a pressure side and a suction side, and a leading edge and a trailing edge with a chord having a chord length extending therebetween, the wind turbine blade extending in a spanwise direction between a root end and a tip end, wherein the blade comprises an outer surface, the method comprising the steps of
cutting an access window through the blade,
pivotally connecting a first end of a cover member to the outer surface of the blade, and
releasably fastening a second end of the cover member to the outer surface of the blade to cover the access window.

Typically, the outer surface is a profiled surface, wherein preferably the access window is provided at a location of said profiled surface.

In another aspect, the present invention relates to a method of manufacturing a wind turbine blade according to the present invention, the method comprising the steps of:
manufacturing a pressure side shell half and a suction side shell half,
arranging a spar structure within the pressure side shell half or within the suction side shell half, the spar structure comprising a first part and a second part, the first and second part being releasably coupled to each other,
cutting an access window through the suction side shell half or the pressure side shell half, preferably the suction side shell half,
pivotally connecting a first end of a cover member to the outer surface of the blade,
releasably fastening a second end of the cover member to the outer surface of the blade to cover the access window,
joining the pressure side shell half and the suction side shell half for obtaining a closed shell body,
cutting the closed shell body along a cutting plane substantially normal to the spanwise direction of the closed shell body to obtain a first and a second blade segment, each blade segment comprising part of the pressure side shell half and part of the suction side shell half, wherein the spar structure extends across the cutting plane,
uncoupling the first and second part of the spar structure,
separating the first blade segment from the second blade segment,
joining and sealing the first blade segment to the second blade segment for obtaining the wind turbine blade, wherein the spar structure comprises at least one locking pin for releasably coupling the first part to the second part of the spar structure through aligned respective locking apertures in each of the first and second part of the spar structure.

In a preferred embodiment, the step of uncoupling the first and second part of the spar structure comprises withdrawing the locking pin from the aligned respective apertures in each of the first and second part of the spar structure via the access window.

In a preferred embodiment, the method further comprises a step of re-inserting the locking pin into the aligned respective apertures in each of the first and second part of the spar structure via the access window, after joining and sealing the first blade segment to the second blade segment.

By manufacturing the wind turbine blade using a spar structure comprising a first part and a second part, releasably coupled to each other, an efficient and elegant method is provided for segmenting and re-assembling such wind turbine blade, including uncoupling and preferably re-coupling said parts.

Preferably, the pressure side shell half and the suction side shell half are manufactured over the entire length of the wind turbine blade, i.e. over their entire final length. The pressure side shell half and the suction side shell half will typically be adhered or bonded to each other near the leading edge and near the trailing edge. Each shell half may comprise longitudinally/spanwise extending load carrying structures, such as one or more main laminates or spar caps, preferably comprising reinforcement fibers such as glass fibers, carbon fibers, aramid fibers, metallic fibers, such as steel fibers, or plant fibers, or mixtures thereof. The shell halves will typically be produced by infusing a fiber lay-up of fiber material with a resin such as epoxy, polyester or vinyl ester.

Usually, the pressure side shell half and the suction side shell half are manufactured using mould structures. Each of the shell halves may comprise spar caps or main laminates provided along the respective pressure and suction side shell members. The spar caps or main laminates may be affixed to the inner faces of the shell halves. The spar structure is preferably a longitudinally extending load carrying structure, preferably comprising a beam or spar box for connecting and stabilizing the shell halves. The spar structure may be adapted to carry a substantial part of the load on the blade.

The spar structure preferably comprises a first part and a second part, the first and second part being releasably coupled to each other, such as releasably fixed or locked to each other. In some embodiments, the first and second part are releasably coupled to each other by one or more mechanical devices. In some embodiments, the first and second parts are releasably coupled to each other by a mechanical locking mechanism. The second part of the spar structure may advantageously comprise a spar beam or a spar box. The first part of the spar structure may preferably comprise an arrangement for receiving the second part, such as a hollow member or a sheath.

The step of joining the pressure side shell half and the suction side shell half for obtaining a closed shell body may be carried out using any suitable joining mechanism or process, including adhesives, bonding material, mechanical fasteners, and any combination of the same. The closed shell is preferably a full-length preform of the final wind turbine blade obtainable by the method of the present invention.

In the step of cutting the closed shell body the closed shell is cut along a cutting plane substantially normal to the spanwise direction or longitudinal axis of the closed shell. In other words, the spanwise direction or longitudinal axis of the closed shell is substantially normal to said cutting plane. It is preferred that only the shell body is cut along the cutting plane. It is also preferred that the spar structure is not cut in this step.

In some embodiments, the first blade segment constitutes 30-80%, such as 40-70%, of the entire longitudinal extent of the blade. In some embodiments, the second blade segment constitutes 10-50%, such as 20-40%, of the entire longitudinal extent of the blade. Advantageously, the spar structure extends across the cutting plane, preferably without being cut. The first and second blade segments may include respective ends with complimentary joint sections that are joinable at a chord-wise joint.

The step of uncoupling the first and second part of the spar structure is preferably performed by unlocking a mechanical locking mechanism. After separating the first blade segment from the second blade segment, the individual blade segments may be individually transported, for example by respective trucks. The first blade segment and the second blade segment may be transported to an erection site for a wind turbine. The step of joining and sealing the first blade segment to the second blade segment for obtaining the wind turbine blade may advantageously be performed at the erection site of the wind turbine. This step may be carried out using any suitable joining and/or sealing mechanism or process, including adhesives, bonding material, mechanical fasteners, and any combination of the same.

In a preferred embodiment, the first part of the spar structure is fixed to the first blade segment. In some embodiments, the first part of the spar structure is glued or adhered to the first blade segment, preferably to both the partial suction side shell half and the partial pressure side shell half. In a preferred embodiment, the first part of the spar structure does not extend beyond the first blade segment.

According to some embodiments, the second part of the spar structure is fixed, such as glued or adhered, to the second blade segment, preferably to both partial shell halves. The second part of the spar structure preferably extends beyond the second blade segment into the first blade segment. Thus, the second part of the spar structure preferably protrudes from within the second part of the spar structure. In a preferred embodiment, the first blade segment comprises the root end of the blade. In another preferred embodiment, the second blade segment comprises the tip end of the blade. The blade may be also cut into more than two segments.

In some embodiments, the second part of the spar structure comprises a spar member, such as a spar beam or a spar box, the spar box preferably comprising at least one spar beam and at least one spar flange. In some embodiments, the first part of the spar structure comprises a receiving member, preferably a sheath member, for at least partly receiving or enclosing the second part of the spar structure. In some embodiments, the second part of the spar structure comprises a spar member, which is at least partly received or enclosed in a receiving structure. The receiving structure can be a jacket, for example a jacket comprising a mesh or net-like structure. In some embodiments, the jacket is made of the same material as the sheath member of the first part of the spar structure. It is preferred that the jacket is a conductive jacket.

According to some embodiments, the sheath member is substantially box-shaped. In other embodiments the sheath member is hollow. In other embodiments, the sheath member comprises a mesh or a net-structure. In a preferred embodiment, the sheath member is a conductive sheath member. In a preferred embodiment, the conductive sheath member is part of a lightning protection system of the wind turbine blade. In a preferred embodiment the conductive sheath member of the first part and the conductive jacket of the second part are both part of a lightning protections system of a wind turbine blade.

In a preferred embodiment, the spar structure comprises at least one locking pin for releasably coupling the first part to the second part of the spar structure through aligned respective locking apertures in each of the first and second part of the spar structure. In other embodiments, the spar structure comprises two or more, such as three or more, or four or more, locking pins and two or more, such as three or more, or four or more, respective locking apertures in each of the first and second part of the spar structure. Preferably, the locking apertures are respective through holes formed in the sheath member and the spar member, respectively.

In a preferred embodiment, the pressure side shell half and the suction side shell half are manufactured in respective mould halves, preferably by vacuum assisted resin transfer moulding. According to some embodiments, the pressure side shell half, and the suction side shell half each have a longitudinal extent L of 50-90 m, preferably 60-80 m.

The cover member in its open position uncovers opening defined by the access window and advantageously allows for installation of a chordwise locking pin for releasably coupling a first part to a second part of a spar structure. Further, access window may also be used to access internal parts within a wind turbine blade such as connections of a blade lightning protection system or for general maintenance operations. It was found that the access window uncovered by the cover member of the present invention minimizes or completely avoids negative impacts on the aerodynamic performance and structural integrity of the wind turbine blade, while efficiently preventing influx and efflux of liquid or debris.

The present invention also relates to a wind turbine blade obtainable by the method of manufacturing a wind turbine blade as described above. The present wind turbine blade can be easily and efficiently assembled due to its spar structure and its coupling and decoupling properties.

As used herein, the term “spanwise” is used to describe the orientation of a measurement or element along the blade from its root end to its tip end. In some embodiments, spanwise is the direction along the longitudinal axis and longitudinal extent of the wind turbine blade.

### DESCRIPTION OF THE INVENTION

The invention is explained in detail below with reference to an embodiment shown in the drawings, in which

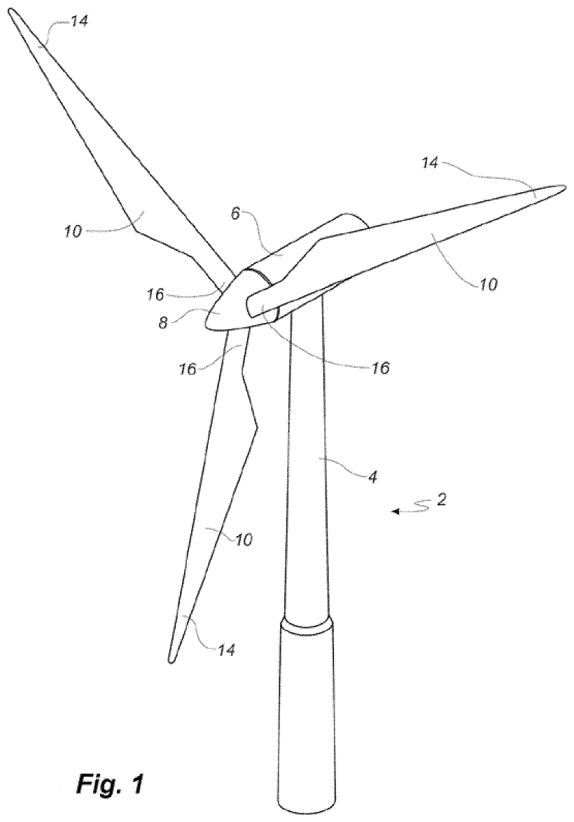

FIG. 1 shows a wind turbine,

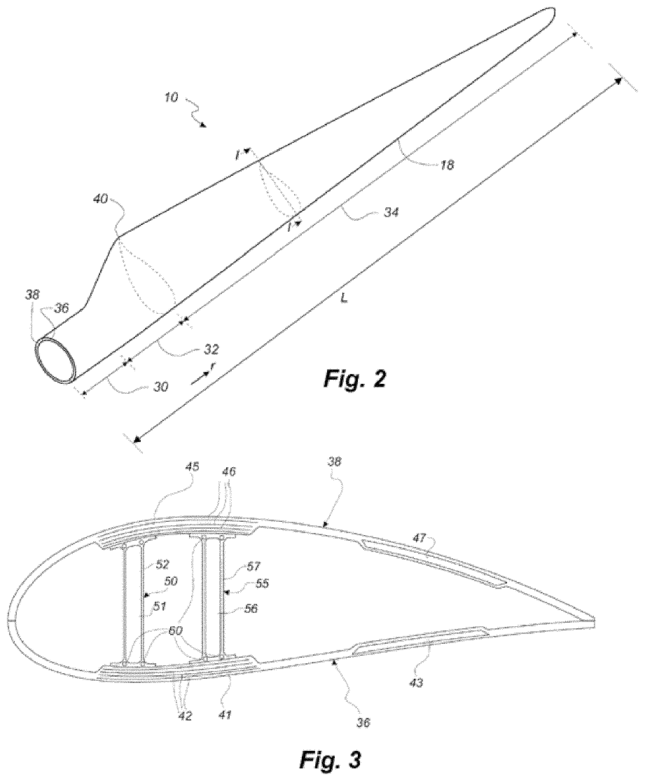

FIG. 2 shows a schematic view of a wind turbine blade,

FIG. 3 shows a schematic view of a cross-section of a wind turbine blade,

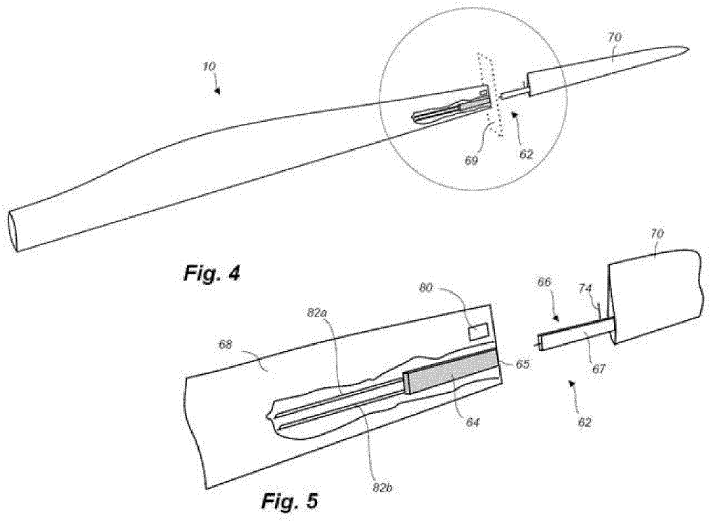

FIG. 4 is a schematic cut-open view of a wind turbine blade,

FIG. 5 is an enlarged view of the encircled section in FIG. 4, and

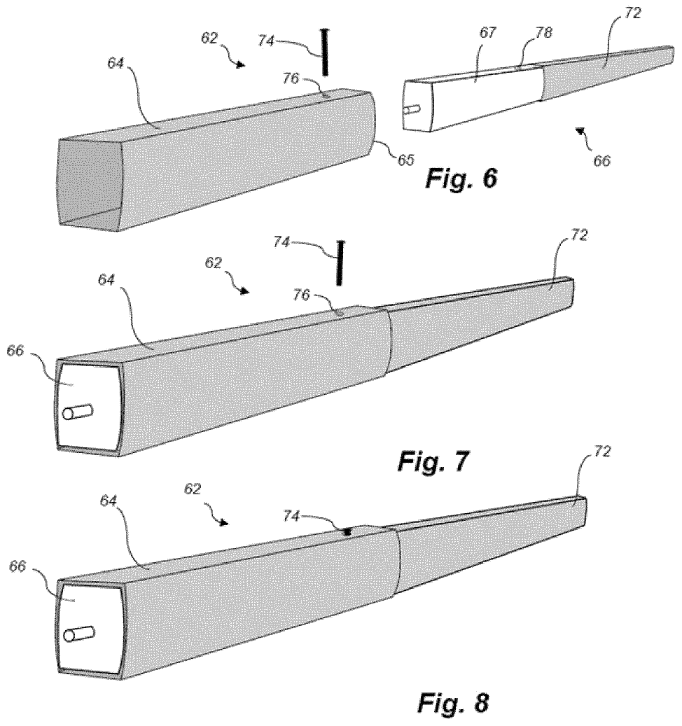

FIGS. 6, 7 and 8 are perspective views of a spar structure,

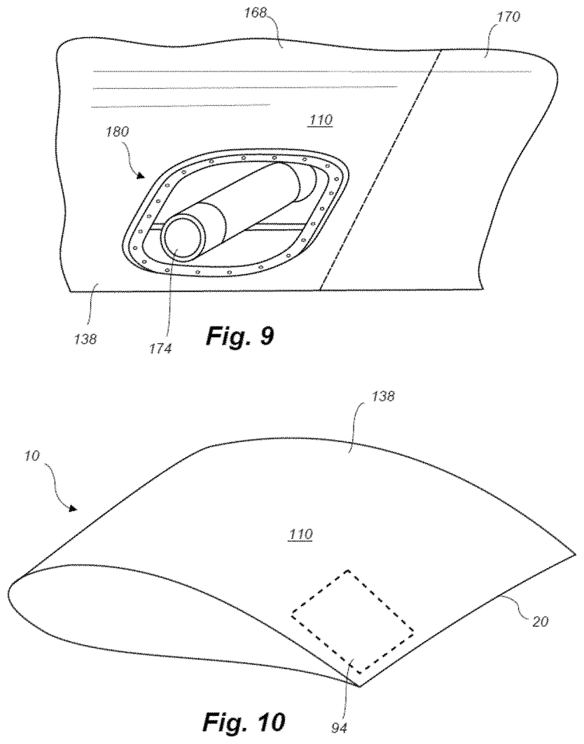

FIG. 9 is a partial perspective view of an access opening of a wind turbine blade,

FIG. 10 is a perspective partial view of a wind turbine rotor blade,

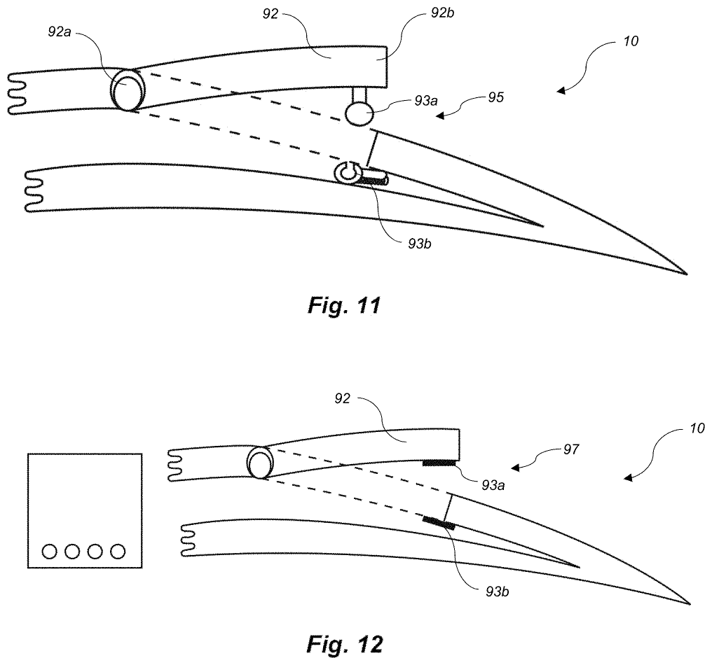

FIG. 11 is a front partial view of a wind turbine rotor blade according to the present invention, wherein push latch mechanism is employed as a fastening mechanism to fasten cover member to the blade,

FIG. 12 is a front partial view of a wind turbine rotor blade according to the present invention, wherein magnetic latch is employed as a fastening mechanism to fasten cover member to the blade, and

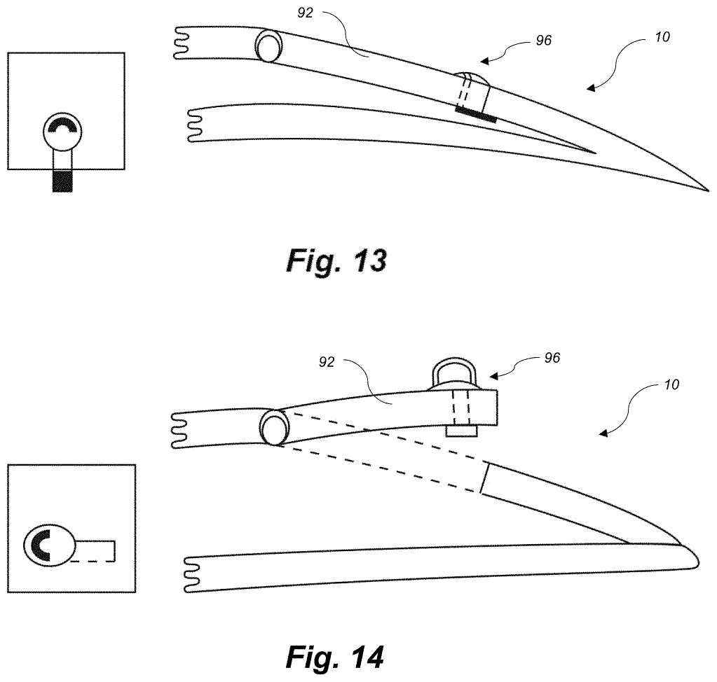

FIG. 13 and FIG. 14 are front partial views of a wind turbine rotor blade according to the present invention, wherein twist latch mechanism is employed as a fastening mechanism to fasten cover member to the blade.

### DETAILED DESCRIPTION

FIG. 1 illustrates a conventional modern upwind wind turbine according to the so-called “Danish concept” with a tower 4, a nacelle 6 and a rotor with a substantially horizontal rotor shaft. The rotor includes a hub 8 and three blades 10 extending radially from the hub 8, each having a blade root 16 nearest the hub and a blade tip 14 farthest from the hub 8. The rotor has a radius denoted R.

FIG. 2 shows a schematic view of a wind turbine blade 10. The wind turbine blade 10 has the shape of a conventional wind turbine blade and comprises a root region 30 closest to the hub, a profiled or an airfoil region 34 farthest away from the hub and a transition region 32 between the root region 30 and the airfoil region 34. The blade 10 comprises a leading edge 18 facing the direction of rotation of the blade 10, when the blade is mounted on the hub, and a trailing edge 20 facing the opposite direction of the leading edge 18.

The airfoil region 34 (also called the profiled region) has an ideal or almost ideal blade shape with respect to generating lift, whereas the root region 30 due to structural considerations has a substantially circular or elliptical cross-section, which for instance makes it easier and safer to mount the blade 10 to the hub 8. The diameter (or the chord) of the root region 30 may be constant along the entire root area 30. The transition region 32 has a transitional profile gradually changing from the circular or elliptical shape of the root region 30 to the airfoil profile of the airfoil region 34. The chord length of the transition region 32 typically increases with increasing distance r from the hub 8. The airfoil region 34 has an airfoil profile with a chord extending between the leading edge 18 and the trailing edge 20 of the blade 10. The width of the chord decreases with increasing distance r from the hub.

A shoulder 40 of the blade 10 is defined as the position, where the blade 10 has its largest chord length. The shoulder 40 is typically provided at the boundary between the transition region 32 and the airfoil region 34. FIG. 2 also illustrates the longitudinal extent L, length or longitudinal axis of the blade.

It should be noted that the chords of different sections of the blade normally do not lie in a common plane, since the blade may be twisted and/or curved (i.e. pre-bent), thus providing the chord plane with a correspondingly twisted and/or curved course, this being most often the case in order to compensate for the local velocity of the blade being dependent on the radius from the hub.

The blade is typically made from a pressure side shell part 36 and a suction side shell part 38 that are glued to each other along bond lines at the leading edge 18 and the trailing edge of the blade 20.

FIG. 3 shows a schematic view of a cross section of the blade along the line I-I shown in FIG. 2. As previously mentioned, the blade 10 comprises a pressure side shell part 36 and a suction side shell part 38. The pressure side shell part 36 comprises a spar cap 41, also called a main laminate, which constitutes a load bearing part of the pressure side shell part 36. The spar cap 41 comprises a plurality of fibre layers 42 mainly comprising unidirectional fibres aligned along the longitudinal direction of the blade in order to provide stiffness to the blade. The suction side shell part 38 also comprises a spar cap 45 comprising a plurality of fibre layers 46. The pressure side shell part 38 may also comprise a sandwich core material 43 typically made of balsawood or foamed polymer and sandwiched between a number of fibre-reinforced skin layers. The sandwich core material 43 is used to provide stiffness to the shell in order to ensure that the shell substantially maintains its aerodynamic profile during rotation of the blade. Similarly, the suction side shell part 38 may also comprise a sandwich core material 47.

The spar cap 41 of the pressure side shell part 36 and the spar cap 45 of the suction side shell part 38 are connected via a first shear web 50 and a second shear web 55. The shear webs 50, 55 are in the shown embodiment shaped as substantially I-shaped webs. The first shear web 50 comprises a shear web body and two web foot flanges. The shear web body comprises a sandwich core material 51, such as balsawood or foamed polymer, covered by a number of skin layers 52 made of a number of fibre layers. The blade shells 36, 38 may comprise further fibre-reinforcement at the leading edge and the trailing edge. Typically, the shell parts 36, 38 are bonded to each other via glue flanges.

FIG. 4 is a schematic cut-open, exploded view of a wind turbine blade according to a co-pending application of the present applicant, wherein FIG. 5 is an enlarged view of the encircled section in FIG. 4. A pressure side shell half and a suction side shell half are typically manufactured over the entire length L of the wind turbine blade 10. A spar structure 62 is arranged within the shell. The spar structure 62 comprising a first part 64 and a second part 66 [as shown in FIG. 5], the first and second part being releasably coupled to each other, as shown in FIG. 8. The method advantageously comprises fixing the first part 64 of the spar structure 62 to one or both of the shell halves within the first blade segment 68 and fixing the second part 66 of the spar structure to one or both of the shell halves within the second blade segment 70.

The shell halves are then closed and joined, such as glued together for obtaining a closed shell, which is subsequently cut along a cutting plane 69 substantially normal to the spanwise direction or longitudinal extent of the blade to obtain a first blade segment 68 and a second blade segment 70. The cutting plane 69 coincides with an end surface 65 of the first part 64 of the spar structure.

As seen in FIGS. 4 and 5, the spar structure 62 extends across the cutting plane 69. As best seen in FIG. 5, the first part 64 of the spar structure 62, which takes the form of a box-shaped sheath member for at least partly enclosing the second part 66 of the spar structure in the illustrated embodiment, is fixed to the first blade segment 68. The second part 66 of the spar structure 62, which comprises a spar box in the illustrated embodiment, is fixed to the second blade segment 70, wherein the second part 66 extends beyond the second blade segment 70 into the first blade segment 68, when the blade segments are assembled.

FIG. 5 also illustrates an access opening 80 within the upper half of the illustrated shell for accessing the spar structure and coupling and uncoupling the first and second part of the spar structure 62. For uncoupling, a locking pin, as illustrated in FIGS. 6-8, is withdrawn from the aligned respective apertures 76, 78 in each of the first and second part of the spar structure via the access opening 80. Prior to, or after, joining and sealing the first blade segment 68 to the second blade segment 70 for obtaining the wind turbine blade, the method advantageously comprises re-coupling the first and second part of the spar structure, via the access opening 80, as illustrated in FIG. 8, by re-inserting the locking pin 74 into the aligned respective apertures 76, 78 in each of the first and second part of the spar structure. As seen in FIGS. 4 and 5, the cutting step dl) does not comprise cutting the spar structure, only the shell halves are cut. In addition, two shear webs 82a, 82b are arranged within the first blade segment.

FIGS. 6, 7 and 8 illustrate an embodiment of the spar structure 62 with the first part 64 in the form of a conductive, box-shaped sheath member according to a co-pending application of the present applicant. Preferably, the conductive sheath member is part of a lightning protection system of the wind turbine blade. The second part 66 of the spar structure comprises a box spar 67, part of which is encased in a jacket 72, for example comprising a conductive mesh 72. The spar structure 62 comprises a locking pin 74 for releasably coupling the first part 64 to the second part 66 of the spar structure through aligned respective locking apertures 76, 78 in each of the first and second part of the spar structure.

FIG. 9 is a partial perspective view of an access opening 180 of a wind turbine blade 10. The wind turbine blade 10 comprises a shell member 138, such as a suction side shell half, with an outer surface 110. The shell member 138 may comprise a first segment 168, such as a root end segment, connected to a second segment 170, such as a tip end segment. An access opening 180 is provided in the blade shell member 138 for allowing access to a hollow space within the blade, e.g. for inserting or withdrawing a locking pin 174 as described above.

FIG. 10 is a partial perspective view of a wind turbine rotor blade 10 with an outer surface 110, here illustrating the outer surface of a suction side shell half 138. In manufacturing the blade of the present invention, an access window 94 is cut through the blade for allowing access to the interior thereof, as indicated by the hatched line in FIG. 10. In the illustrated example of FIG. 10, the access window is substantially rectangular and is provided close to the trailing edge of the blade.

As illustrated in FIG. 11, a cover member 92 is configured to cover the access window 94. The cover member 92 comprises a first end 92a and a second end 92b. The first end 92a is pivotally connected to the outer surface 110 of the blade 10 and the second end 92b is releasably and self-engagingly fastened to the outer surface 110 of the blade 10 through a fastening mechanism. In one embodiment of the invention, the fastening mechanism may be a self-engaging and externally releasable fastening mechanism. The cover member 92 is capable of pivotally moving between an open position and a closed position relative to the blade 10. In the open position of the cover member 92, the interior of the blade 10 may be accessed through the access window 94, and in the closed position, the cover member 92 substantially flushes with the outer surface 110 of the blade 10. The fastening mechanism includes but not limited to push latch mechanism 95 as shown in FIG. 11. The push latch mechanism 95 includes a male fastening member 93a and a female fastening member 93b. The push latch mechanism 95 is an exemplary mechanism that typically opens upon receiving an input force to unlock and subsequently an input force from the same direction locks the mechanism. In the locked or closed position, the male fastening member 93a is self-engagingly accommodated in the female fastening member 93b. In an exemplary embodiment of the push latch mechanism 95 shown in FIG. 11, the female fastening member 93a is a ball mounted on an inner surface of the cover member 92. The ball latches and releases from the hook provisioned on the outer surface 110 of the blade 10 based on the position and the external input force applied on the cove member 92 between open and closed positions.

The second end 92b of the cover member 92 is self-engagingly fastened to the outer surface 110 of the blade 10. In other words, that there is no requirement of any external member or tool for fastening the cover member 92 with the blade 10. The fastening mechanism of the present invention is self-reliant or self-engaged in that it allows the male fastening member 93a to engage with the female fastening member 93b without having to use any external tool and to remain engaged until an external disengaging force is applied.

For instance, considering push-latch mechanism 95 as an exemplary fastening mechanism, a push force applied on the external surface of the cover member 92 towards the blade 10 causes engagement between the male fastening member 93a and the female fastening member 93b and hence eliminates the requirement of external members such as screw, nut and bolt etc.

Further, the fastening mechanism is externally releasable, in that the fastening mechanism may be disengaged by external operation. Considering the exemplary push-latch mechanism 95, external input force on the cover member 92 proximal to second end 92a causes release or dis-engagement of the cover member 92 from the blade 10. This eliminates the need for using either manual or powered tools to operate the cover member between the closed position and the open position.

As illustrated in FIG. 12, in another exemplary embodiment of the invention, the fastening mechanism is a magnetic latch 97. The magnetic latch 97 is a system of magnets that can either attach directly and self-engagingly to another magnetic structure or will move when the magnets are nearby. A first magnet 93a may be mounted on the inner surface of the cover member 92 and a second magnet 93b may be attached to the outer surface 110 of the blade 10 proximal to access window 94. The first magnet 93a and the second magnet 93b of opposite polarity may be attracted to each other to bring the cover member 92 to a self-engagingly closed position. Further, a magnet of same polarity may induce repulsive force to move the cover member 92 away from the closed position.

As in case of the push-latch mechanism 95, the exemplary magnetic latch 97 allows self-engagement between the cover member 92 and the blade 10. The magnetic latch 97 is externally releasable as well using a suitable technique. A magnet of one polarity may be provisioned on an inner surface of the cover member 92 at its second end 92b, this acts as a male fastening member 93a. Further, a magnet of opposite polarity or a member having magnetic properties may be provisioned in the blade 10, to act as a female fastening member 93b. As the cover member 92 is moved towards the blade 10, the male fastening member 93a engages with the female fastening member 93b, and remains engaged until an external disengaging force is applied and hence eliminates the requirement of external members such as screw, nut and bolt etc.

Further, the magnetic latch may be externally releasable by means such as introducing magnetic member of polarity same as that of the male fastening member 93a provisioned on the cover member 92. This may create repulsive force and thus causes release of the cover member 92. This eliminates the need for using tools either manual or powered, to operate the cover member between the closed position and the open position.

As illustrated in FIG. 13 and FIG. 14, in yet another exemplary embodiment of the invention, the self-engaging and externally releasable fastening mechanism is twist latch mechanism 96. The twist latch mechanism 96 refers to a mechanism that typically remains flush with the outer surface when not in use, as shown in FIG. 13, but can be opened up by an externally applied twist force which allows movement from the closed position towards the open position as shown in FIG. 14. The twist latch mechanism 96 includes a threaded fastening member which may unfasten when twisted facilitating opening of the cover member 92.

As in case of push-latch mechanism 95 and the magnetic latch 97, the twist latch mechanism 96 allows self-engagement between the cover member 92 and the blade 10. The twist latch mechanism 96 is externally releasable as well. The twist-latch mechanism 97 may include a knob-like member, which may be turned in clockwise direction to cause engagement and in anti-clockwise direction to unlock or disengage. Thus, the cover member 92 and the blade 10 may be self-engaged by twisting the knob-like structure in clockwise direction and may be externally released by twisting in the antic-clockwise direction. This eliminates the requirement of external members such as screw, nut and bolt etc.

In some embodiments, there may be other self-engaging and externally releasable fastening mechanisms that may be employed apart from the above. Other such self-engaging and externally releasable fastening mechanisms may include but are not limited to snap lock, detent lock etc and the same should be construed as part of the present invention.

The invention is not limited to the embodiments described herein and may be modified or adapted without departing from the scope of the present invention.

A technical contribution for the disclosed wind turbine blade and method of manufacturing the same is that it improves access opening and closing and engaging arrangement.

According to one embodiment of the invention, there is provided a wind turbine blade having a profiled contour including a pressure side and a suction side, and a leading edge and a trailing edge with a chord having a chord length extending therebetween, the wind turbine blade extending in a spanwise direction between a root end and a tip end, wherein the blade comprises an outer surface, an access window extending through the blade, a cover member for covering the access window, wherein a first end of the cover member is pivotally connected to the outer surface of the blade and a second end of the cover member is releasably fastened to the outer surface of the blade.

According to another embodiment of the invention, there is provided a method of manufacturing a wind turbine blade having a profiled contour including a pressure side and a suction side, and a leading edge and a trailing edge with a chord having a chord length extending therebetween, the wind turbine blade extending in a spanwise direction between a root end and a tip end, wherein the blade comprises an outer surface, the method comprising the steps of: cutting an access window through the blade, pivotally connecting a first end of a cover member to the outer surface of the blade, and releasably fastening a second end of the cover member to the outer surface of the blade to cover the access window.

According to yet another embodiment of the invention, there is provided a method of manufacturing a wind tur-bine blade according to the present invention, the method comprising the steps of: manufacturing a pressure side shell half and a suction side shell half, arranging a spar structure within the pressure side shell half or within the suction side shell half, the spar structure comprising a first part and a second part, the first and second part being releasably coupled to each other, cutting an access window through the suction side shell half or the pressure side shell half, preferably the suction side shell half, pivotally connecting a first end of a cover member to the outer surface of the blade, releasably fastening a second end of the cover member to the outer surface of the blade to cover the access window, joining the pressure side shell half and the suction side shell half for obtaining a closed shell body, cutting the closed shell body along a cutting plane substantially normal to the spanwise direction of the closed shell body to obtain a first and a second blade segment, each blade segment comprising part of the pressure side shell half and part of the suction side shell half, wherein the spar structure extends across the cutting plane, uncoupling the first and second part of the spar structure, separating the first blade segment from the second blade segment, joining and sealing the first blade segment to the second blade segment for obtaining the wind turbine blade, wherein the spar structure comprises at least one locking pin for releasably coupling the first part to the second part of the spar structure through aligned respective locking apertures in each of the first and second part of the spar structure.

While the invention has been described in detail in connection with only a limited number of embodiments, it should be readily understood that the invention is not limited to such disclosed embodiments. Further, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not limited by the foregoing description, but is only limited by the scope of the appended claims.

### LIST OF REFERENCE NUMERALS

4 tower
6 nacelle
8 hub
10 blade
14 blade tip
16 blade root
18 leading edge
20 trailing edge
30 root region
32 transition region
34 airfoil region
36 pressure side shell part
38, 138 suction side shell part
40 shoulder
41 spar cap
42 fibre layers
43 sandwich core material
45 spar cap
46 fibre layers
47 sandwich core material
50 first shear web
51 core member
52 skin layers
55 second shear web
56 sandwich core material of second shear web
57 skin layers of second shear web
60 filler ropes
62 spar structure
64 first part
65 end surface of first part
66 second part
67 spar member
68,168 first blade segment
69 cutting plane
70,170 second blade segment
72 jacket/mesh
74,174 locking pin
76 aperture
78 aperture
80,180 access opening
82 shear web
90 access arrangement
92 cover member
92a first end of the cover member
92b second end of the cover member
93a male fastening member
93b female fastening member
94 access window
95 push-latch mechanism
96 twist-latch mechanism
97 magnetic latch
110 outer blade surface
L length
r distance from hub
R rotor radius

1. A wind turbine blade, comprising:
a profiled contour comprising a pressure side and a suction side, and a leading edge and a trailing edge with a chord having a chord length extending therebetween, the wind turbine blade extending in a spanwise direction between a root end and a tip end;
an outer surface;
an access window extending through the wind turbine blade; and
a cover member for covering the access window, wherein a first end of the cover member is pivotally connected to the outer surface of the wind turbine blade and a second end of the cover member is releasably fastened to the outer surface of the wind turbine blade.

2-20. (canceled)

21. The method of claim 1, wherein the cover member substantially flushes with the outer surface of the wind turbine blade.

22. The method of claim 1, wherein the first end of the cover member is hinged to the outer surface of the wind turbine blade.

23. The method of claim 1, wherein the second end of the cover member is releasably fastened to the outer surface of the wind turbine blade through a fastening mechanism.

24. The method of claim 23, wherein the fastening mechanism comprises a male fastening member and a female fastening member.

25. The method of claim 23, wherein the cover member is configured to cover the fastening mechanism in a closed position of the cover member.

26. The method of claim 23, wherein the fastening mechanism is a push-latch mechanism.

27. The method of claim 23, wherein the fastening mechanism is a twist-latch mechanism.

28. The method of claim 23, wherein the fastening mechanism is a magnetic latch.

29. A method of manufacturing a wind turbine blade having a profiled contour including a pressure side and a suction side, and a leading edge and a trailing edge with a chord having a chord length extending therebetween, the wind turbine blade having an outer surface extending in a spanwise direction between a root end and a tip end, the method comprising:
cutting an access window through the wind turbine blade;
pivotally connecting a first end of a cover member to the outer surface of the wind turbine blade; and
releasably fastening a second end of the cover member to the outer surface of the wind turbine blade to cover the access window.

30. A method of manufacturing a wind turbine blade, the method comprising:
manufacturing a pressure side shell half and a suction side shell half;
arranging a spar structure within the pressure side shell half or within the suction side shell half, the spar structure comprising a first part and a second part, the first and second part being releasably coupled to each other;
cutting an access window through the suction side shell half or the pressure side shell half;
pivotally connecting a first end of a cover member to the outer surface of the wind turbine blade;
releasably fastening a second end of the cover member to the outer surface of the wind turbine blade to cover the access window;
joining the pressure side shell half and the suction side shell half for obtaining a closed shell body;
cutting the closed shell body along a cutting plane substantially normal to the spanwise direction of the closed shell body to obtain a first blade segment and a second blade segment, each of the first and second blade segments comprising part of the pressure side shell half and part of the suction side shell half, wherein the spar structure extends across the cutting plane;
uncoupling the first and second part of the spar structure;
separating the first blade segment from the second blade segment; and
joining and sealing the first blade segment to the second blade segment for obtaining the wind turbine blade;
wherein the spar structure comprises at least one locking pin for releasably coupling the first part to the second part of the spar structure through aligned respective locking apertures in each of the first and second part of the spar structure.

31. The method of claim 30, wherein uncoupling the first and second part of the spar structure comprises withdrawing the locking pin from the aligned respective apertures in each of the first and second part of the spar structure via the access window.

32. The method of claim 30, further comprising re-inserting the locking pin into the aligned respective apertures in each of the first and second part of the spar structure via the access window, after joining and sealing the first blade segment to the second blade segment.

33. The method of claim 30, wherein the cover member is flush with the outer surface of the wind turbine blade.

34. The method of claim 30, wherein the first end of the cover member is hinged to the outer surface of the wind turbine blade.

35. The method of claim 30, wherein the second end of the cover member is releasably fastened to the outer surface of the wind turbine blade through a fastening mechanism.

36. The method of claim 30, wherein the cover member is configured to cover the fastening mechanism in a closed position of the cover member.

37. The method of claim 30, wherein the fastening mechanism is a push-latch mechanism.

38. The method of claim 30, wherein the fastening mechanism is a twist-latch mechanism.

39. The method of claim 30, wherein the fastening mechanism is a magnetic latch.
